(19) United States
(12) Patent Application Publication
(10) Pub. No.: US 2009/0284465 A1
(43) Pub. Date: Nov. 19, 2009

(54) CAPACITIVE MOTION DETECTION DEVICE AND INPUT DEVICE USING THE SAME

(75) Inventors: Toshiyuki Oki, Miyagi-ken (JP); Nobuaki Haga, Miyagi-ken (JP); Daisuke Takai, Miyagi-ken (JP); Kazuya Inagaki, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/511,981

(22) Filed: Jul. 29, 2009

Related U.S. Application Data
(63) Continuation of application No. PCT/JP2008/051321, filed on Jan. 29, 2008.

(30) Foreign Application Priority Data
Jan. 31, 2007 (JP) 2007-21332

(51) Int. Cl. G01P 15/125; G09G 5/00

(52) U.S. Cl. 345/156; 73/514.32

(57) ABSTRACT

When the mode is switched to a motion detection mode, using a changeover switch, the mode is switched to the motion detection mode by pressing the changeover switch. In this mode, motion detection is performed by moving a hand in an area to be operated. When the mode is switched from the motion detection mode to a normal mode, the hand is moved away from the area to be operated, or the changeover switch is again pressed. Moreover, when the hand is distant from a capacitive sensor, it is determined that a motion input operation is being performed. When the hand is close to the capacitive sensor, it is determined that no motion input operation is being performed, and thus the motion detection mode is changed.

### CLAIM OF PRIORITY

This application claims benefit of the Japanese Patent Application No. 2007-021332 filed on Jan. 31, 2007, which is hereby incorporated by reference.

### BACKGROUND OF THE INVENTION

1. Field of the Invention

The present invention relates to a capacitive motion detection device detecting, by the use of capacitances, the motions of an object to be detected in an area to be operated and an input device using the same.

2. Description of the Related Art

Methods for detecting the motions of an object to be detected, such as a human body, include, for example, a method for detecting the motions of a person by capturing the images of the person and outputting the motions to a control unit in a personal computer (PC), using at least one camera and an image processing unit (for example, Japanese Unexamined Patent Application Publication No. 2001-87549). Moreover, the methods include a method for outputting the motions to a control unit in a PC by embedding, for example, an acceleration sensor in a device and moving the device in specific directions.

However, in the method, in which a camera and image processing are used, the costs of hardware, software, and the like are high, and the space in which the method is used is limited because a specific space for capturing camera images needs to be prepared in advance. Moreover, in the method, in which an acceleration sensor is used, the hardware needs to be directly moved. When the hardware main body is moved, the device may be affected by vibrations. Moreover, even when a small input device in which an acceleration sensor is embedded is used, the small input device needs to be held in hand and operated.

### SUMMARY OF THE INVENTION

In view of the aforementioned problems, the present invention provides a capacitive motion detection device and an input device using the same. The capacitive motion detection device has a simple configuration, has few limitations regarding the operating environment, does not affect a device due to vibrations, and need not include a specific input device.

A capacitive motion detection device according to a first aspect of the present invention includes two or more detection electrode/drive electrode pairs in each of which a capacitance is formed between a detection electrode and a drive electrode, the detection electrode/drive electrode pairs being provided at individual direction detection positions for an area to be operated, the area being operable from two or more directions, motion detecting means for performing motion detection of an object to be detected in the area to be operated from a variation in a capacitance obtained in each of the detection electrode/drive electrode pairs, and switching means for switching a mode to a mode of the motion detection.

In this arrangement, since the motions of an object to be detected in an area to be operated are detected on the basis of a capacitance obtained in each of the two or more detection electrode/drive electrode pairs, a capacitive motion detection device that has a simple configuration, has few limitations regarding the operating environment, is not likely to affect a device due to vibrations, and need not include a specific input device can be implemented.

In the capacitive motion detection device according to the first aspect of the present invention, the switching means is preferably a capacitive sensor, and when a variation in a capacitance detected by the capacitive sensor is less than a predetermined threshold value, the mode is preferably switched to the mode of the motion detection. In this case, it is preferable that the capacitive sensor also function as a position input device.

In the capacitive motion detection device according to the first aspect of the present invention, the switching means is preferably a changeover switch, and when the changeover switch has been operated or when the changeover switch is being operated, the mode is preferably switched to the mode of the motion detection.

An input device according to a second aspect of the present invention includes a device main body that includes the aforementioned capacitive motion detection device, and control means for operating the device main body on the basis of detection of a motion of the object to be detected, the detection being performed by the capacitive motion detection device, the control means being included in the device main body.

### BRIEF DESCRIPTION OF THE DRAWINGS

FIG. 1 shows an input device using a capacitive motion detection device according to an embodiment of the present invention;

FIGS. 2A and 2B show the principle of capacitive motion detection according to the embodiment of the present invention;

FIG. 3 shows the principle of the capacitive motion detection according to the embodiment of the present invention;

FIGS. 4A and 4B show mode switching in the capacitive motion detection according to the embodiment of the present invention;

FIGS. 5A to 5D show mode switching in the capacitive motion detection according to the embodiment of the present invention;

FIGS. 6A to 6C show other exemplary input devices using the capacitive motion detection device according to the embodiment of the present invention;

FIGS. 7A and 7B show mode switching in the capacitive motion detection according to the embodiment of the present invention;

FIGS. 8A to 8D show mode switching in the capacitive motion detection according to the embodiment of the present invention; and

FIGS. 9A and 9B show other exemplary input devices using the capacitive motion detection device according to the embodiment of the present invention.

### DESCRIPTION OF THE PREFERRED EMBODIMENTS

An embodiment of the present invention will now be described in detail with reference to the attached drawings.

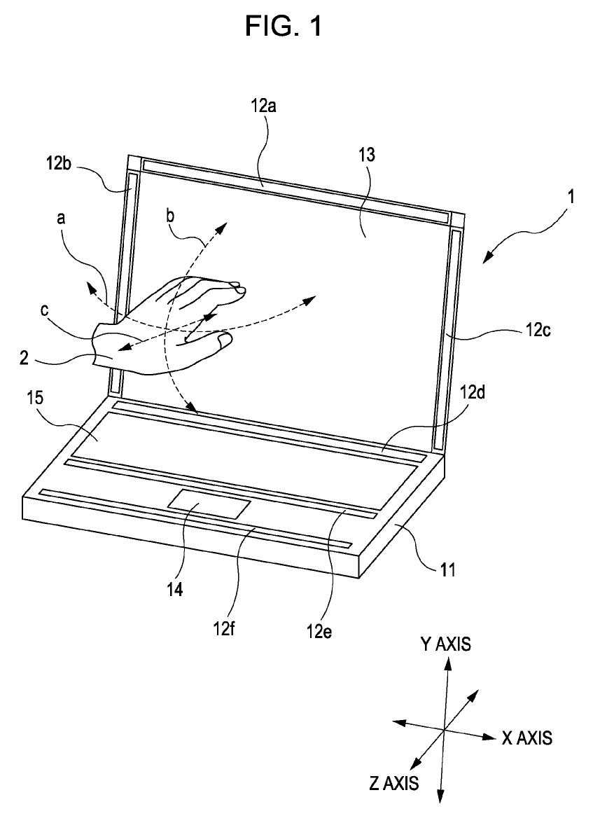

FIG. 1 shows a notebook personal computer (PC) according to the present invention serving as an input device. The notebook PC 1 includes electrodes 12a, 12b, 12c, and 12d formed around a monitor 13, an electrode 12e formed opposite the electrode 12d with a keyboard 15 between the electrode 12e and the electrode 12d, and an electrode 12f formed opposite the electrode 12e with a glidepoint 14 between the electrode 12f and the electrode 12e. These electrodes are provided at individual direction detection positions for an area to be operated, the area being operable from two or more directions, and constitute two or more detection electrode/drive electrode pairs in each of which a capacitance is formed between a detection electrode and a drive electrode. In this case, an area in front of the monitor 13 is set as an area to be operated serving as the detection reference for a hand 2 that is an object to be detected, the horizontal direction (a dashed arrow line a) of the monitor area is set as the X-axis, the vertical direction (a dashed arrow line b) of the monitor area is set as the Y-axis, and the depth direction (a dashed arrow line c) of the monitor area is set as the Z-axis.

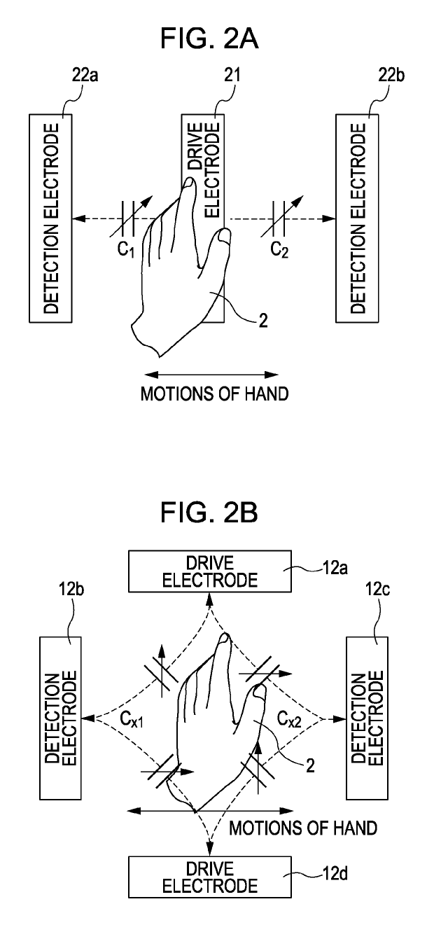

When the position of an object to be detected, for example, a human body, is detected using capacitances, an arrangement in which a drive electrode 21 is disposed at the center, and detection electrodes 22a and 22b are disposed on the both sides of the drive electrode 21, as shown in FIG. 2A, is adopted. In this arrangement, a capacitance C1 is formed between the drive electrode 21 and the detection electrode 22a, and a capacitance C2 is formed between the drive electrode 21 and the detection electrode 22b. The position of the hand 2 can be detected by obtaining the difference between the capacitances C1 and C2.

When it is difficult to dispose an electrode at the center of the monitor 13, as is the case with the notebook PC 1, the position of the hand 2 can be detected by adopting an arrangement of electrodes shown in FIG. 2B. That is, the position of the hand 2 can be detected by setting the electrodes 12a and 12d disposed on the upper and lower sides of the monitor 13 as drive electrodes and setting the electrodes 12b and 12c disposed on the right and left sides of the monitor 13 as detection electrodes. FIG. 2B shows a case where the position of the hand 2 moving in the X-axis direction is detected.

While, in the embodiment, the drive electrodes 12a and 12d are separately disposed on the upper and lower sides, and the detection electrodes 12b and 12c are disposed on the right and left sides, for example, the number of electrodes and the arrangement of electrodes are not limited as long as detection electrodes and drive electrodes are disposed at positions where an object to be detected in the area to be operated can be detected (as long as detection electrode/drive electrode pairs exist).

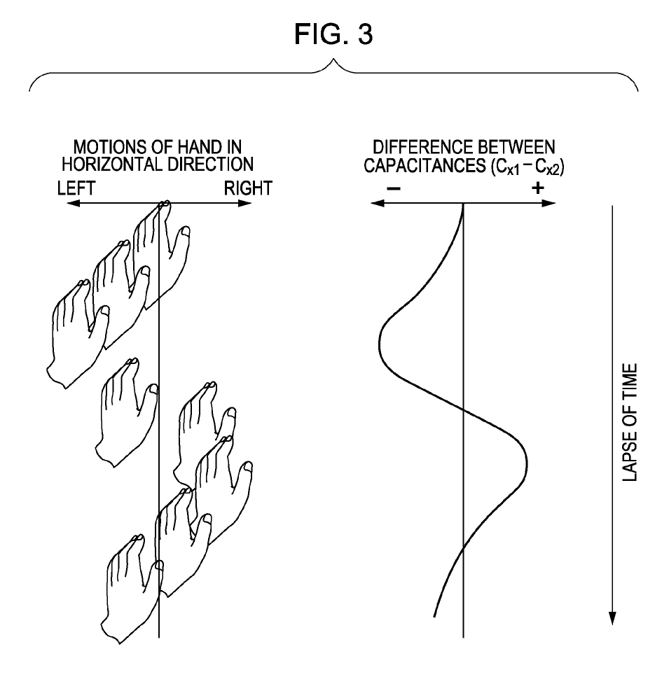

The motions of the hand 2 in the area to be operated can be detected from a capacitance obtained in each of the detection electrode/drive electrode pairs. Capacitances are always formed between the detection electrodes 12b and 12c and the drive electrodes 12a and 12d. In this case, a capacitance Cx1 is formed between the detection electrode 12b and the drive electrodes 12a and 12d, and a capacitance Cx2 is formed between the detection electrode 12c and the drive electrodes 12a and 12d. In such an arrangement, when the hand 2 moves in the right or left direction of the X-axis direction (the horizontal direction), the capacitances Cx1 and Cx2 change due to capacitances formed with the hand 2. For example, when the hand 2 moves in the right direction, the capacitance Cx1 increases, and the capacitance Cx2 decreases. Thus, the motions of the hand 2 in the X-axis direction (the horizontal direction) can be detected by obtaining the difference between the capacitances Cx1 and Cx2 (Cx1−Cx2), as shown in FIG. 3.

Moreover, the motions of the hand 2 in the Y-axis direction (the vertical direction) can be detected by setting the electrodes 12a and 12d disposed on the upper and lower sides of the monitor 13 as detection electrodes, setting the electrodes 12b and 12c disposed on the right and left sides of the monitor 13 as drive electrodes, and using a detection method that is similar to that described above. Moreover, the motions of the hand 2 in the Z-axis direction (the depth direction) can be detected by setting one of the electrodes 12a, 12b, 12c, and 12d around the monitor 13 and the electrodes 12e and 12f near the keyboard 15 and the glidepoint 14 as detection electrodes and setting an electrode near the center among the determined detection electrodes as a drive electrode, for example, setting the electrodes 12a and 12f as detection electrodes and setting the electrode 12d as a drive electrode. In this manner, the motions of the hand 2 in the three axis directions can be detected.

The notebook PC 1 serving as an input device includes a device main body 11 and a control unit that is included in the device main body 11 and operates the device main body 11 on the basis of motion detection. The device main body 11 includes detection electrode/drive electrode pairs described above and a motion detection circuit that detects the motions of an object to be detected in the area to be operated from a variation in a capacitance obtained in each of the detection electrode/drive electrode pairs.

In the notebook PC 1 including a capacitive motion detection device according to the present invention, it is expected that, when the keyboard 15 is being operated, the hand 2 will be close to the capacitive motion detection device, and thus an input operation on the keyboard 15 may be detected as a motion. Thus, in the present invention, assuming that a keyboard input operation and a motion input operation are seldom performed at the same time, an arrangement that switches between a mode in which a user (an operator) intentionally performs a motion input operation and a mode (a normal mode) in which the user performs an input operation (in this case, a keyboard input operation) other than a motion input operation is adopted. That is, the capacitive motion detection device includes a switching unit that switches the mode to the motion detection mode.

Regarding the switching unit, for example, keyboard input detection, using a separate capacitive sensor or diverting an existing capacitive sensor, may be provided to detect a keyboard input operation, and when a capacitance detected by the capacitive sensor is less than a predetermined threshold value, the mode may be switched to the motion detection mode. Alternatively, a changeover switch may be provided, and when the changeover switch has been operated or when the changeover switch is being operated, the mode may be switched to the motion detection mode.

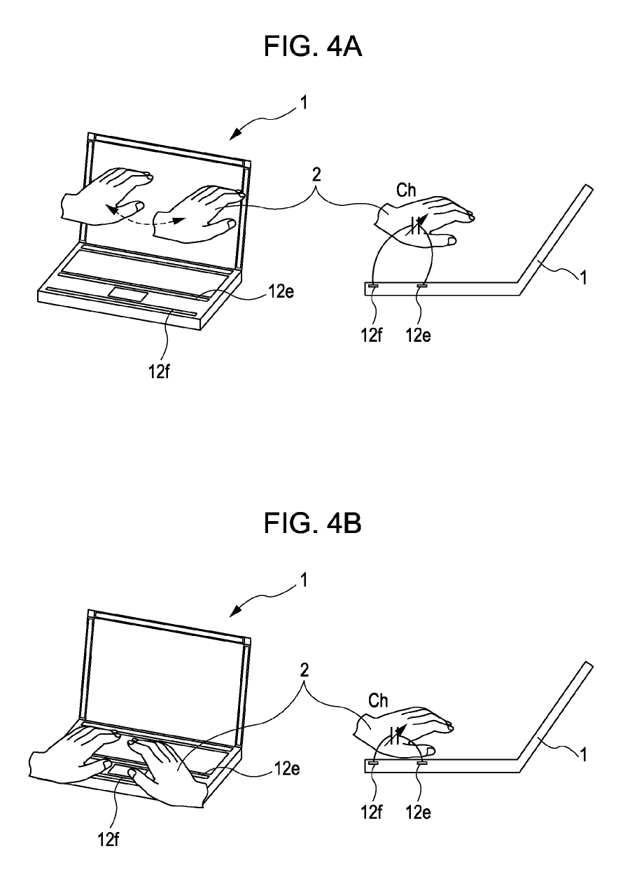

In a case where the mode is switched to the motion detection (motion input operation) mode, using a capacitive sensor, switching is performed, as shown in FIGS. 4A and 4B. In this case, the electrodes 12e and 12f constitute a capacitive sensor. When the hand 2 is distant from the capacitive sensor, as shown in FIG. 4A, it is determined that a motion input operation is being performed. When the hand 2 is close to the capacitive sensor, as shown in FIG. 4B, it is determined that no motion input operation is being performed (a keyboard input operation is being performed), and thus the motion detection (motion input operation) mode is changed. In this case, when a capacitance Ch between the capacitive sensor and the hand 2 is less than a threshold value, it is determined that the hand 2 is distant from the capacitive sensor, and thus the mode is switched to the motion detection mode. When the capacitance Ch between the capacitive sensor and the hand 2 is equal to or more than the threshold value, it is determined that the hand 2 is close to the capacitive sensor, and thus the mode is switched to the normal mode. In this case, the glidepoint 14 is also a capacitive sensor and may be used to switch the mode to the motion detection mode in addition to being used as a general position input device. In an arrangement in which a capacitance that is smaller than that in a case where an operation as position input is detected is set as a threshold value, and it is detected whether the hand 2 exists near the keyboard 15, a capacitive changeover switch can be provided by diverting an existing position input device. In this arrangement, for example, in a notebook PC, any sensor need not be separately provided, and thus the space and the cost can be reduced.

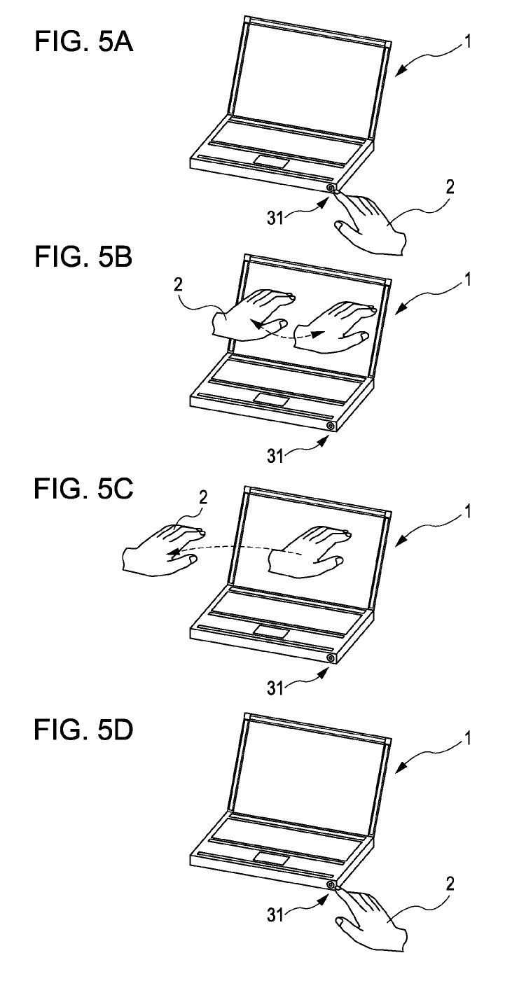

In a case where the mode is switched to the motion detection (motion input operation) mode, using a changeover switch, switching is performed, as shown in FIGS. 5A to 5D. In this case, the mode is first switched to the motion detection mode by pressing a changeover switch 31, as shown in FIG. 5A. In this mode, motion detection is performed in the aforementioned manner by moving the hand 2 in the area to be operated, as shown in FIG. 5B. When the mode is switched from the motion detection mode to the normal mode, the hand 2 is moved away from the area to be operated, as shown in FIG. 5C, or the changeover switch 31 is again pressed, as shown in FIG. 5D.

In this case, the position, size, and shape of the changeover switch 31 are not limited to those shown in FIGS. 5A to 5D. For example, switching between the motion detection mode and the normal mode may be performed by the operation of a specific key of the keyboard 15 or a specific operation on the glidepoint 14. Moreover, an operation may be performed by combining the changeover switch 31 and a capacitive sensor. For example, in a case where a motion is input by the hand 2, with the other hand being put near the keyboard 15, while an operation is being performed in the motion detection mode, using the changeover switch 31, when the capacitance Ch between the capacitive sensor and the hand 2 is equal to or more than a threshold value, only motions in two dimensions may be detected without detecting a motion in the Z-axis direction. According to this method, a case where motions in the respective directions of axes other than the Z-axis cannot be detected because a variation in a capacitance in the Z-axis direction is excessive even with a slight motion of the hand 2 near the keyboard 15 can be prevented.

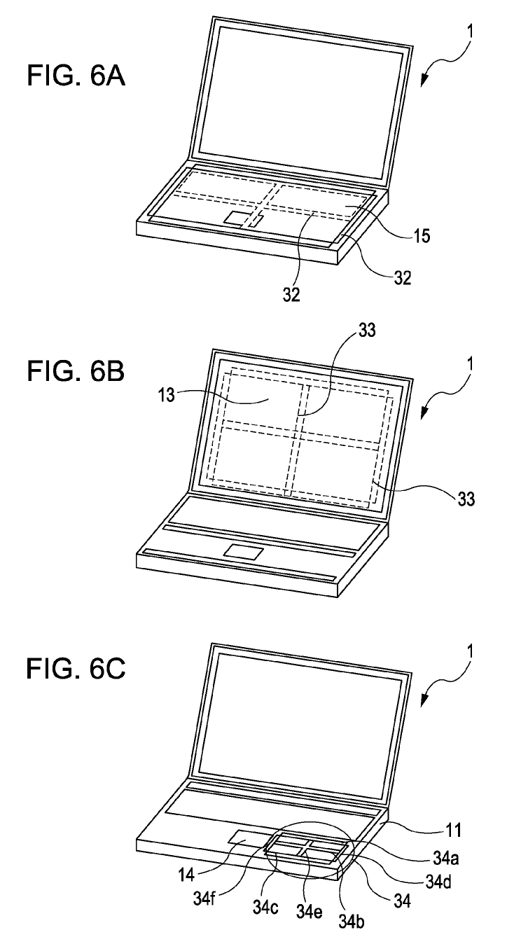

A case has been described where an area in front of the monitor 13 is set as an area to be operated serving as the detection reference for the hand 2, which is an object to be detected. Alternatively, an area above the keyboard 15 may be set as an area to be operated serving as the detection reference for the hand 2, which is an object to be detected, the horizontal direction of the keyboard area may be set as the X-axis, the vertical direction of the keyboard area may be set as the Y-axis, and the depth direction of the keyboard area may be set as the Z-axis, as shown in FIG. 6A. In this case, an electrode 32 is provided on a surface that includes the keyboard 15 to constitute detection electrodes and drive electrodes.

Moreover, an electrode 33 may be provided in the monitor 13 so as to constitute detection electrodes and drive electrodes, as shown in FIG. 6B. Alternatively, an electrode unit (a plurality of detection electrode/drive electrode pairs) 34 that includes a plurality of electrodes may be provided in another part of the device main body 11. For example, the electrode unit 34 and the glidepoint 14 may be provided side by side, as shown in FIG. 6C. In this arrangement, motion detection can be performed in an area where a hand of an operator is ordinarily located, and thus the operator can readily perform motion detection by a slight movement of the hand.

In the small electrode unit 34 shown in FIG. 6C, motion detection in the X-axis direction (the horizontal direction) is performed by setting electrodes 34d and 34f as detection electrodes and setting an electrode 34e as a drive electrode, and motion detection in the Z-axis direction (the depth direction) is performed by setting electrodes 34a and 34c as detection electrodes and setting an electrode 34b as a drive electrode. In this case, the principle of motion detection is as described above (FIG. 2A).

Even in a case where the small electrode unit 34 shown in FIG. 6C is used, a capacitive sensor may be provided, and when a capacitance detected by the capacitive sensor is less than a predetermined threshold value, the mode may be switched to the motion detection mode. Alternatively, a changeover switch may be provided, and when the changeover switch has been operated or when the changeover switch is being operated, the mode may be switched to the motion detection mode.

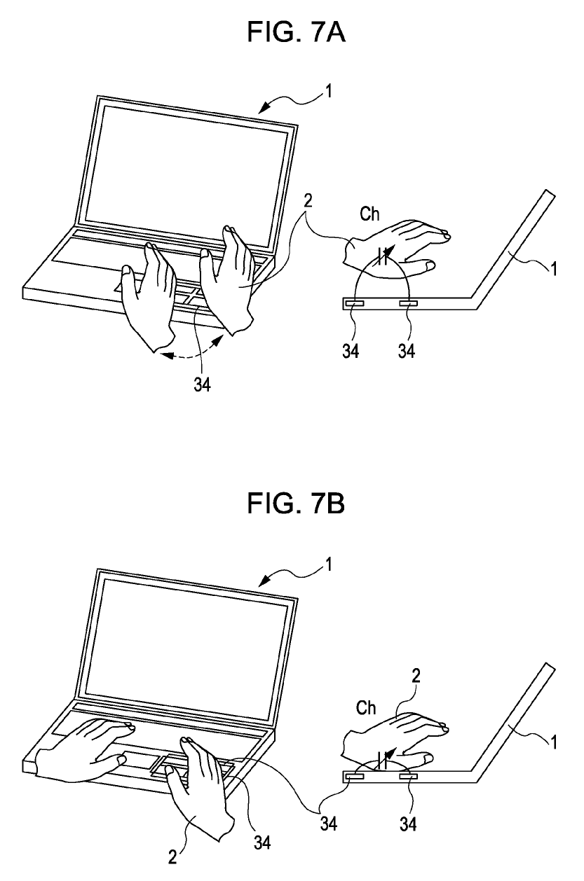

In a case where the mode is switched to the motion detection (motion input operation) mode, using a capacitive sensor, switching is performed, as shown in FIGS. 7A and 7B. In this case, two electrodes of the electrode unit 34 constitute a capacitive sensor. When the hand 2 is distant from the capacitive sensor, as shown in FIG. 7A, it is determined that a motion input operation is being performed. When the hand 2 is close to the capacitive sensor, as shown in FIG. 7B, it is determined that no motion input operation is being performed (a keyboard input operation is being performed), and thus the motion detection (motion input operation) mode is changed. In this case, when the capacitance Ch between the capacitive sensor and the hand 2 is less than a threshold value, it is determined that the hand 2 is distant from the capacitive sensor, and thus the mode is switched to the motion detection mode. When the capacitance Ch between the capacitive sensor and the hand 2 is equal to or more than the threshold value, it is determined that the hand 2 is close to the capacitive sensor, and thus the mode is switched to the normal mode.

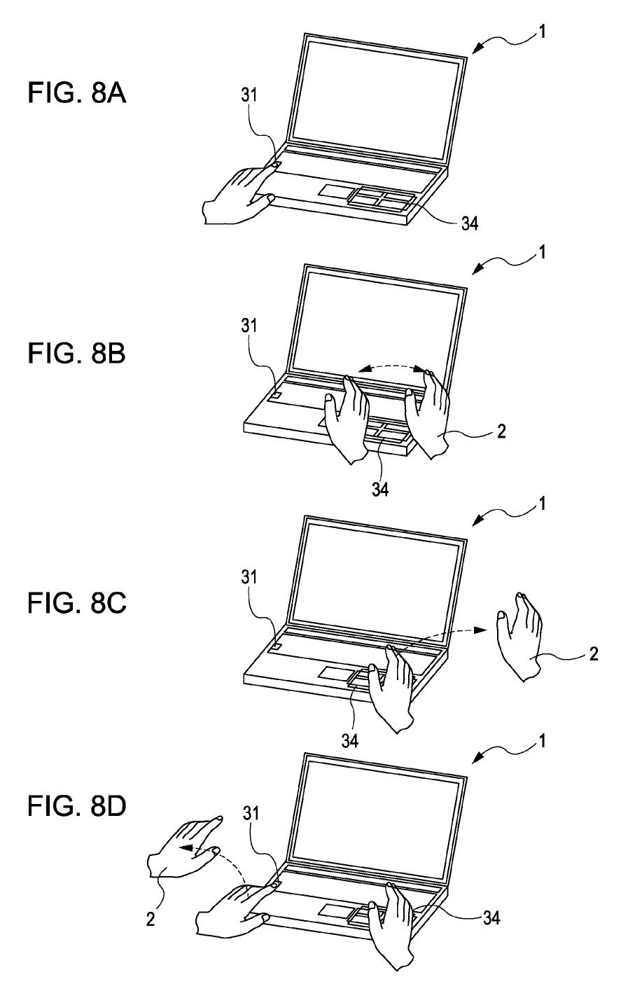

Moreover, in a case where the mode is switched to the motion detection (motion input operation) mode, using a changeover switch, switching is performed, as shown in FIGS. 8A to 8D. In this case, the mode is first switched to the motion detection mode by pressing the changeover switch 31, as shown in FIG. 8A. In this mode, motion detection is performed in the aforementioned manner by moving the hand 2 in the area to be operated, as shown in FIG. 8B. When the mode is switched from the motion detection mode to the normal mode, the hand 2 is moved away from the area to be operated, as shown in FIG. 8C, or the changeover switch 31 is again pressed, as shown in FIG. 8D. Mode switching can be performed, using one hand (in this case, a left hand), and a motion input operation can be performed, using the other hand (in this case, a right hand), by separating the electrode unit 34 from the changeover switch 31 (providing the electrode unit 34 and the changeover switch 31 on both sides), as shown in FIGS. 8A to 8D. Moreover, the capacitance of a hand operating the changeover switch 31 can be prevented from affecting motion detection by separating the electrode unit 34 from the changeover switch 31.

In this case, the position, size, and shape of the changeover switch 31 are not limited to those shown in FIGS. 8A to 8D. For example, switching between the motion detection mode and the normal mode may be performed by the operation of a specific key of the keyboard 15 or a specific operation on the glidepoint 14.

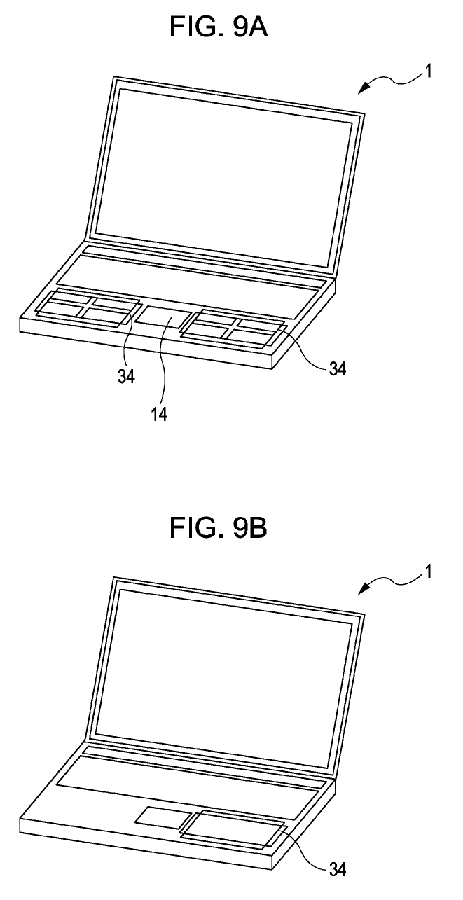

The electrode unit 34 may be provided on both sides of the glidepoint 14, as shown in FIG. 9A. Moreover, the number of electrodes of the electrode unit 34 may be reduced, as shown in FIG. 9B. In the case of the electrode unit 34 shown in FIG. 9B, motion detection can be performed according to a principle that is similar to that in FIG. 2B.

As described above, according to the embodiment, since the motions of an object to be detected in an area to be operated are detected on the basis of a capacitance obtained in each of the two or more detection electrode/drive electrode pairs, a capacitive motion detection device that has a simple configuration, has few limitations regarding the operating environment, is not likely to affect a device due to vibrations, and need not include a specific input device can be implemented. In an input device that includes such a capacitive motion detection device, various types of operations, for example, changing the hierarchical level of a page of an application, turning pages, scrolling a screen, and operating a specific part, can be performed by capacitive motion detection.

The present invention is not limited to the aforementioned embodiment and may be changed in various forms. For example, right or left, upper or lower, front or back, and the number, positions, sizes, and shapes of members in the aforementioned embodiment may be fitly changed. Moreover, since the device main body includes a capacitive sensor, the function may be used as a function of detecting the approach of a person. For example, an arrangement may be adopted in which it is determined whether a person is approaching a device that includes the capacitive motion detection device, and when a person is moving away from the device, the mode is automatically changed to a power saving mode; when a person is approaching the device, the power saving mode is automatically cancelled. Moreover, changes may be fitly made in the present invention without departing from the scope of the present invention.

What is claimed is:

1. A capacitive motion detection device comprising:
two or more detection electrode/drive electrode pairs in each of which a capacitance is formed between a detection electrode and a drive electrode;
motion detecting means for performing noncontact motion detection of an object to be detected in an area to be operated in two or more axis directions from a variation in a capacitance obtained in each of the detection electrode/drive electrode pairs; and
switching means for switching a mode to a mode of the motion detection.

2. The capacitive motion detection device according to claim 1, wherein the switching means is a capacitive sensor, and when a capacitance detected by the capacitive sensor is less than a predetermined threshold value, the mode is switched to the mode of the motion detection.

3. The capacitive motion detection device according to claim 2, further comprising:
input means operated by the object to be detected,
wherein the capacitive sensor is disposed near the input means.

4. The capacitive motion detection device according to claim 3, wherein the threshold value is set so that the capacitance detected by the capacitive sensor exceeds the threshold value while the input means is being operated.

5. The capacitive motion detection device according to claim 3, wherein the input means is a capacitive position input device and also functions as the capacitive sensor.

6. The capacitive motion detection device according to claim 3, wherein the input means is a keyboard, and at least one of electrodes of the capacitive sensor is disposed on a front side of the keyboard.

7. The capacitive motion detection device according to claim 1, wherein the switching means is a capacitive sensor, and when a capacitance detected by the capacitive sensor is equal to or more than a predetermined threshold value, the mode is switched to a mode in which the motion detection is not performed.

8. The capacitive motion detection device according to claim 7, further comprising:
input means operated by the object to be detected,
wherein the capacitive sensor is disposed near the input means.

9. The capacitive motion detection device according to claim 8, wherein the threshold value is set so that the capacitance detected by the capacitive sensor exceeds the threshold value while the input means is being operated.

10. The capacitive motion detection device according to claim 8, wherein the input means is a capacitive position input device and also functions as the capacitive sensor.

11. The capacitive motion detection device according to claim 8, wherein the input means is a keyboard, and at least one of electrodes of the capacitive sensor is disposed on a front side of the keyboard.

12. The capacitive motion detection device according to claim 1, wherein an electrode in at least one of the detection electrode/drive electrode pairs is set as a drive electrode when a motion in one axis direction is detected and is set as a detection electrode when a motion in another axis direction is detected.

13. The capacitive motion detection device according to claim 1, wherein the switching means is a changeover switch, and when the changeover switch has been operated or when the changeover switch is being operated, the mode is switched to the mode of the motion detection.

14. An input device comprising:
a device main body that includes the capacitive motion detection device according to claim 1; and
control means for operating the device main body on the basis of detection of a motion of the object to be detected, the detection being performed by the capacitive motion detection device, the control means being included in the device main body.
